(19) United States
(12) Patent Application Publication
(10) Pub. No.: US 2015/0040840 A1
(43) Pub. Date: Feb. 12, 2015

(54) NON-BATTERY POWERED ANIMAL TRACKING SYSTEM

(71) Applicant: ZF Friedrichshafen AG, Friedrichshafen (DE)

(72) Inventors: Ronald Muetzel, Hawthorn Woods, IL (US); Thomas Roesch, Friedrichshafen (DE)

(73) Assignee: ZF Friedrichshafen AG, Friedrichshafen (DE)

(21) Appl. No.: 13/961,286

(22) Filed: Aug. 7, 2013

(51) Int. Cl. A01K 11/00; G01S 5/02

(52) U.S. Cl. CPC A01K 11/006; G01S 5/0294
USPC 119/721; 342/450

(57) ABSTRACT

An animal tracking system may include an actuator with a generator that creates electrical energy upon motion of the actuator. The system may utilize the electrical energy to transmit a signal to determine the location of an animal. The system also utilizes the electrical energy to notify the animal when it reaches a predefined location.

### BACKGROUND

Animal tracking and locating devices allow owners and caregivers to monitor the location of their pets to ensure they are safe and secure. Animal locating devices also allow scientists to monitor the location of wild animals in their natural habitat, or farmers to monitor the location of livestock. Locating devices are also used in conjunction with invisible fences to limit the movement of animals to defined areas. Animal locating devices may also alert the owners when the pet has strayed from the defined area. Current animal locating devices rely on electricity to power the device and to locate or secure the animal. To prevent tethering the animals to a power source, current animal locating devices utilize batteries to provide electricity for the devices. However, batteries only provide power for limited periods of time. The animal locating devices powered by batteries will not function as the batteries run out of power, which may prevent the owners from locating and securing their pets.

Therefore, there is a need for an animal tracking system that can operate independent of an external power source.

### SUMMARY OF THE INVENTION

The descriptions below include systems and methods for transmitting signals and notifying animals from non-battery powered animal tracking devices.

According to one aspect a tracking system may be attached to an animal and may comprise an actuator coupled to a generator. The system may also comprise a transmitter connected to the generator. The generator may be operable to generate electrical energy without the use of a battery upon movement of the actuator. The transmitter may be operable to utilize the electrical energy to send a signal wirelessly indicative of the location of the actuator.

According to another aspect a tracking system may be attached to an animal and may comprise an actuator integrated with a generator. The generator may be operable to generate electrical energy without the use of a battery upon movement of the actuator. The system may also comprise a notifier device connected to the actuator. The notifier device may be operable to utilize the electrical energy to notify the animal when the animal reaches a predefined location.

According to another aspect a method of operating a tracking system attached to an animal may comprise generating electrical energy upon movement of an actuator that is attached to an animal; powering a notifier device with the electrical energy; and notifying the animal with the notifier device when the animal reaches a predefined location.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The exemplary systems and methods described below may be more fully understood by reading the following description in conjunction with the drawings, in which

FIG. 1A is a cross section of an example of a radio-controlled switch according to an exemplary animal tracking system;

FIG. 1B is a schematic diagram of an example of a radio-controlled switch according to an exemplary animal tracking system;

FIG. 2 is an exemplary implementation of an animal tracking system;

FIG. 3 is a schematic diagram of another exemplary animal tracking system; and

FIG. 4 is a flow diagram of a method for operating an exemplary animal tracking system.

### DETAILED DESCRIPTION

The exemplary systems and methods as described herein may take a number of different forms. Not all of the depicted components may be required and some implementations may include additional, different, or fewer components from those expressly described in this disclosure. Variations in the arrangement and type of the components may be made without departing from the spirit or scope of the claims as set forth herein.

A non-battery powered animal tracking system may produce electrical energy when moved. The system may utilize the electrical energy to transmit a signal to determine the location of an animal. The system may also utilize the electrical energy to notify the animal when it reaches a predefined location. By producing its own electrical energy, the system may advantageously be available to transmit a signal to locate the animal or notify the animal without regard to an external power source, such as a battery. While the tracking system may be described in relation to non-human animals, one skilled in the art will recognize that the tracking system may be applicable to humans as well and should be interpreted as pertaining to any type of animal.

A radio-controlled switch with an antenna, a transmitter assembly, and a generator may be used in the tracking system. The antenna may be electrically connected to the transmitter assembly to emit a signal that can be generated by the transmitter assembly. The transmitter assembly may be located on a circuit carrier and the antenna may be held on a carrier substrate within the radio-controlled switch that is separate from the circuit carrier. An example radio-controlled switch may be found in commonly-assigned U.S. patent application Ser. No. 13/636,306, the contents of which are incorporated herein by reference in their entirety. An example generator may be found in commonly-assigned U.S. patent application Ser. Nos. 13/636,307 and 13/636,309, the contents of which are incorporated herein by reference in their entirety.

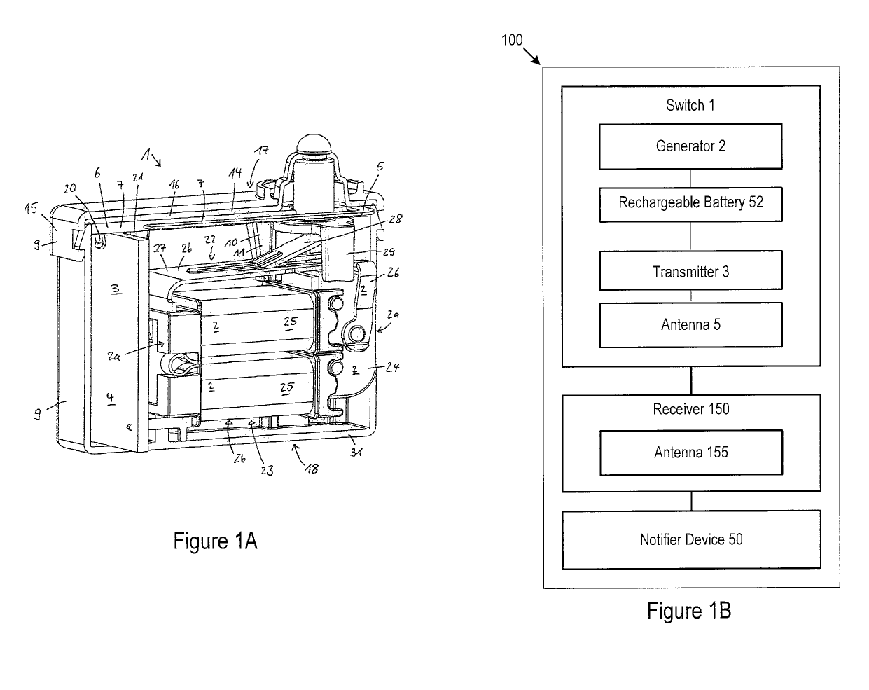

FIG. 1A shows the cross section of exemplary switch 1, which is particularly implemented as an energy-independent radio-controlled switch. Such an energy-independent switch draws its energy from its movement, by which generator 2 of switch 1 is placed into operation. Generator 2 may be, for example an induction generator, a piezo generator, or any other generating device. Generator 2 may provide energy to transmitter assembly 3. The energy may be buffered, for example, in a capacitor or an inductor. Generator 2 may provide energy to notifier device 50, as shown in FIG. 1B. Notifer device 50 may notify or alert the animal of its location.

Switch 1 may be any type of actuator, for example, a motion activated switch, in which a magnetic element is accelerated during movement of the switch to reverse the polarity of the core of an induction coil of the generator. In general, switch 1 may be implemented as a monostable (one resting position), bistable (two resting positions), or metastable (stable against small changes, unstable against larger changes) radio-controlled switch. Switch 1 may be a mechanical switch, a pendulum, or a piezoelectric device.

Transmitter assembly 3 may generate a signal using the generated energy. Transmitter assembly 3 may be connected to antenna 5 such that the signal may be emitted as a radio signal from antenna 5. Transmitter assembly 3 may include circuitry to condition, modulate, or format the transmitted signal into a particular type of wireless signal. For example, the transmitter assembly may module the signal according to modulation schemes known in the art, such as FM, AM, and PM, or more sophisticated schemes such as CDMA. The transmitter assembly may advantageously condition the signal to comply with a wireless standard, such as IEEE 802.11. Transmitter assembly 3 may have circuit carrier 4, for example, in the form of a circuit board, which supports the electronics of transmitter assembly 3. Antenna 5 may be held on carrier substrate 6, for example an antenna carrier, which is separate from circuit carrier 4 of transmitter assembly 3. Circuit carrier 4 and carrier substrate 6 may be separate substrates, which may advantageous reduce interference between circuits deposed on circuit carrier 4 and antenna 5.

Generator 2 in switch 1 may be small yet still provide high energy upon actuation or movement of switch 1. Generator 2 may be a miniaturized generator 2 in the form of an induction snap generator in which magnetic element 24 is moved relative to induction coil 25. In addition, further compact generators may be used for generator 2, for example, that make use of other mechanisms for energy generation. An example is piezo generators. When generator 2 is implemented as a snap generator, a high acceleration of the magnetic element 24 between two resting points may cause a high temporal change in the magnetic flux, whereby the polarity of the generator core is reversed from the polarity of a switch in the rest position. The change in magnetic flux may cause generator 2 to generate electrical energy.

To generate electrical energy, magnet element 24 may have a permanent magnet, and at least one induction coil with a coil core. Magnet element 24 may be arranged adjacent to the induction coil, and may be movable relative to the coil core to generate a flux change in the core and generate an induction voltage by means of the induction coil. The energy generated by the flux change may be emitted or transferred to another assembly of the switch 1, for example, transmitter assembly 3, or may be stored, for example, in a rechargeable battery, capacitor, or ultra-capacitor.

The movement of switch 1 may generate the force to move magnetic element 24, thereby causing the generator to generate electrical energy. Movement of switch 1 from a stationary position to a non-stationary position may cause the magnetic element 24 to move between resting positions, which may cause generator 2 to generate electrical energy. Similarly, continued movement of switch 1 may cause the magnetic element 24 to move, and may cause generator 2 to generate electrical energy.

FIG. 1B is a schematic diagram of animal tracking system 100. Animal tracking system 100 may also include additional components not shown in FIG. 1B. Animal tracking system 100 may include switch 1, notifier device 50, rechargeable battery 52, receiver 150, and antenna 155. The components of animal tracking system 100 shown in FIG. 1B may correspond in function to similarly numbered components shown in FIG. 1A. Switch 1 (which may include generator 2, transmitter 3, antenna 5), receiver 150, antenna 155, notifier device 50, and rechargeable battery 52 may be housed within a single device, as shown in FIG. 1B, or may be housed in separate devices that are connected or in communication with each other. Transmitter 3 and receiver 150 may be may be combined into a transceiver. Further, one of antenna 5 or antenna 155 may be unnecessary where transmitter 3 and receiver 150 may share one antenna, or where a transceiver is employed in place of transmitter 3 and receiver 150.

Notifier device 50 may alert or otherwise inform the animal attached to animal tracking system 100 that it has reached a predefined location. Notifier device 50 may also discourage the animal from progressing beyond the predefined location. Notifier device 50 may be in contact with the animal's body. Alternatively, notifier device 50 may be separated from the animal.

Notifier device 50 may notify the animal using, for example, physical means, auditory means, or visual means. The animal may dislike the notification means such that the notification means may impede the animal's movement toward or across a predefined location. The notification means may be short in duration or may continue for a certain time, such as while the animal is near or beyond the predefined location. Physical means may include, for example, delivering an electric shock to the animal. The electric shock may be sufficient to inform the animal that it has reached a predefined location, but the electric shock may not permanently harm the animal. Physical means may also include inducing a vibration in notifier device 50 such that the animal is startled when the vibration occurs. Auditory means may include, for example, emitting a loud or unpleasant noise that is heard by the animal. Visual means may include, for example, displaying a bright or flashing light to the animal. The notification means may remain constant or may increase in intensity as the animal approaches and/or crosses the predefined location.

The notification means may also be used to discourage the animal from traveling beyond the predefined location. The same means, different means, or the same means of different intensity as were used to notify the animal may be used to discourage the animal.

Tracking device 100 may include a mechanism to store the energy that is created when tracking device 100 is moved. The stored energy may be used by tracking device 100 to transmit a signal when tracking device 100 is not generating electricity, such as when tracking device 100 is stationary. The stored energy may also be used by tracking device 100 to notify the animal that it has reached or is approaching a predefined location. The mechanism to store energy may include a rechargeable storage battery 52. Alternatively, the energy may be stored in an ultra-capacitor or other energy storage device. By creating its own electrical energy, tracking device 100 may be energy independent and may not require a separate power source, such as a battery to provide energy. As such, tracking device 100 may be reliably operable to transmit a location signal or notify an animal because it does not rely on a separate power source. In this way, tracking device 100 may advantageously always be operable due to its lack of reliance on an external power source.

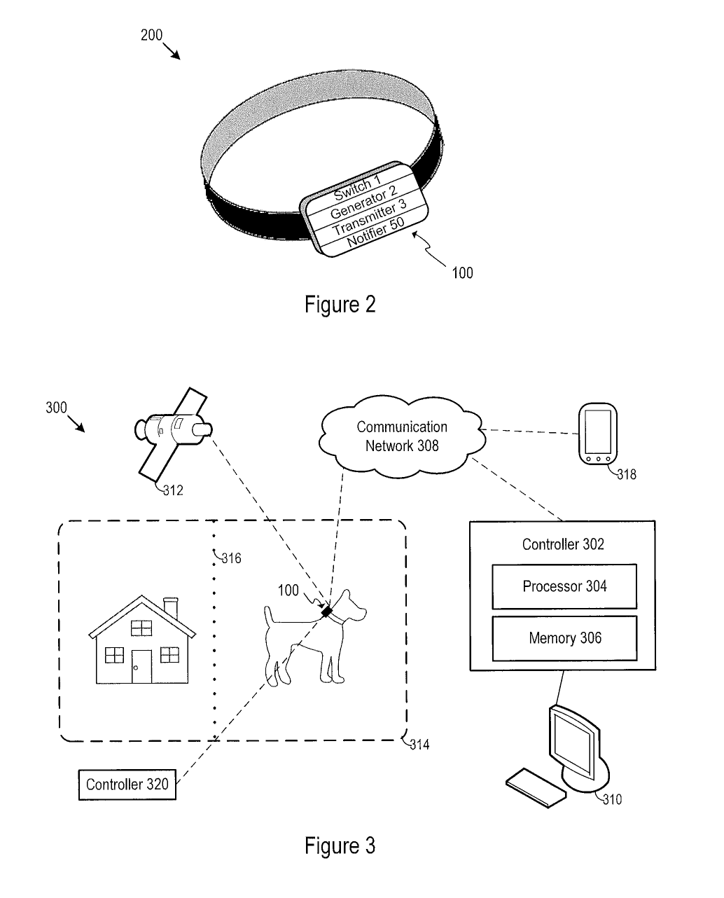

FIG. 2 depicts animal tracking system 200. Animal tracking system 200 may include a tracking device 100 shown and described in relation to FIG. 1B. Other components of animal tracking system 200 may be included in tracking device 100 that are not shown in FIG. 2, such as rechargeable battery 52, for example. The size and shape of tracking device 100 shown in FIG. 2 is for illustrative purposes only. Tracking device 100 may take any size or shape dictated by design requirements and available components. Animal tracking system 200 shown in FIG. 2 may be designed as a collar to be worn around an animal's neck, such as a dog collar.

Animal tracking system 200 may generate electrical energy when the tracking device 100 is moved. As previously described, generator 2 in switch 1 contained in tracking device 100 may create electrical energy when a magnet element is moved between two resting points. Generator 2 may create electrical energy when tracking device 100 is moved. The movement required to cause tracking device 100 to create electrical energy may be provided by an animal that is attached to tracking device 100 or that is wearing tracking device 100. The movement may occur when the animal is moving, such as when walking, running, or performing an activity. Tracking device 100 may be worn or attached to an animal in any known manner, such as on a collar, attached to clothing or a harness worn by the animal, implanted in the animal, or otherwise secured to the animal. Tracking device 100 may be permanently or detachably secured to the animal.

Tracking device 100 may use the electrical energy created by generator 2 to transmit a signal from transmitter 3 and antenna 5. The signal may be used to determine the location of tracking device 100 and any animal attached to tracking device 100. Tracking device 100 may be configured to transmit a signal when tracking device 100 is moved. The movement to cause tracking device 100 to transmit a signal may be the same type of movement that was previously described in relation to tracking device 100 creating electrical energy. Additionally or alternatively, tracking device 100 may be configured to transmit a signal at predefined time intervals, such as every minute or every hour. The time intervals may be modified as required for the particular use of animal tracking system 200 and may be modified throughout the use of animal tracking system 200. Additionally or alternatively, tracking device 100 may be configured to transmit a signal based on a combination of movement and time intervals. Using such a combination may allow tracking device 100 to efficiently use the electrical energy created by generator 2. For example, tracking device 100 may be configured to transmit a signal when moved and to also transmit a signal at specified time intervals when tracking device 100 is stationary. Any other combinations of movement, non-movement, and time intervals may be used by tracking device 100 in determining whether and when to transmit a signal.

FIG. 3 is a schematic diagram of another exemplary animal tracking system 300. The exemplary animal tracking system 300 may include components previously described in reference to FIGS. 1A, 1B, and 2. Animal tracking system 300 may include tracking device 100 attached to an animal in a domestic setting, such on a dog collar as shown in FIG. 3. Additionally or alternatively, animal tracking system 300 may include a tracking device that is attached to wild animals in their natural habitat or in captivity.

Animal tracking system 300 may include a controller 302. Controller 302 may include processor 304 and memory 306. Controller 302 may perform any data or information processing functions related to animal tracking system 300. For example, controller 302 may determine the location of tracking device 100 or send instructions to tracking device 100. Controller 302 may be in communication with tracking device 100 through communication network 308. Communication network 308 may be any number of communication networks and may take any number of forms, such as a wireless network. Tracking device 100 may communicate with controller 302 according to any number of communication protocols, standards, networks, or topologies. As examples, tracking device 100 may communicate across cellular networks or standards (e.g., 2G, 3G, Universal Mobile Telecommunications System (UMTS), GSM® Association, Long Term Evolution (LTE)™, or more), WiMAX, Bluetooth, WiFi (including 802.11a/b/g/n/ac or others), WiGig, Global Positioning System (GPS) networks, and others available at the time of the filing of this application or that may be developed in the future. Tracking device 100 and controller 302 may include processing circuitry, data ports, transmitters, receivers, transceivers, or any combination thereof to communicate across any of the above-listed protocols, standards, networks, or topologies. Controller 302 may be in communication with computer 310. Computer 310 may be any known computer processing device that is capable of storing and processing commands and instructions, such as, for example, a server, computer, tablet, smartphone, or personal data assistant. Controller 302 and computer 310 may be directly linked, as shown in FIG. 3, or may be housed in a single unit. Alternatively, controller 302 may communicate with computer 310 through one or more communication networks, such as communication network 308, as previously described. Controller 302 may be remote from tracking device 100, as shown in FIG. 3, or may be attached or in close proximity to tracking device 100.

Tracking device 100 may transmit a signal indicative of its location and the location of the animal attached to tracking device 100. The signal indicative of location of tracking device 100 may be sent to and/or received from transmitter 3. Transmitter 3 may be a transceiver that is able to both transmit and receive signals. Animal tracking system 300 may determine the location of tracking device 100 by any known means, such as by communication with global positioning satellites 312, as shown in FIG. 3, or by other navigation, triangulation, or signal location methods.

The signals transmitted by tracking device 100 may be received by controller 302. The signals may be transmitted wirelessly through communication network 308, as previously described, or may be wirelessly sent from tracking device 100 to controller 302. Additionally or alternatively, the signals may be transmitted through a hardwired connection between tracking device 100 to controller 302. Processor 304 in controller 302 may process the signals based on logic or instructions stored in memory 306. The logic or instructions in memory 306 may be adjusted at any time. Controller 302 may determine the location of tracking device 100 based on the signals sent by transmitter 3 in tracking device 100. Alternatively, tracking device 100 may determine its own location, and may send its location in the form of, for example, GPS coordinates.

Controller 302 may determine if tracking device 100 is within a predefined area 314. Alternatively, controller 302 may determine the global location of tracking device 100. Predefined area 314 may represent a boundary that the animal is meant to stay within, such as a property line. Predefined area 314 may also be an area within a structure that the animal is meant to refrain from entering, such as a room within a house. Predefined area 314 may be any shape, size, or location in which it would be desirable to ascertain, track, or limit an animal's movement. Predefined area 314 may include a predefined location 316. Predefined location 316 may be a subset of predefined area 314, such as a border or lines between areas. Predefined location 316 may also be separate from predefined area 314. Predefined area 314 may represent an area that an animal is meant to stay in or out of, while predefined location 316 may represent a line that an animal is meant not to cross. Predefined location 316 may also be a concentrated point that the animal is meant to stay away from, such as, for example a deep water well that could harm the animal. Predefined location 316 may also be substantially the same as predefined area 314 depending on the application of animal tracking system 300.

Animal tracking system 300 may include a remote controller 302 or a local controller 320. Local controller 320 may have similar functions and capabilities as described in reference to controller 302. Including local controller 320 that is in communication with tracking device 100 may reduce the signal strength required for a signal transmitted from tracking device 100 to reach a controller. Reducing the required signal strength may allow tracking device 100 to transmit signals more often, more efficiently, or with more information included in the signal. Including local controller 320 may also eliminate the need for communication network 308 to transmit the signal from tracking device 100 to a controller, which may increase the reliability of animal tracking system 300.

Animal tracking system 300 may be able to transmit signals to other devices 318 in order to provide information regarding the animal's location. Transmitter 3 or controller 302 may send the signals directly or through a communication network 308. For example, animal tracking system 300 may transmit a signal to an animal owner's phone alerting the owner that the animal has moved beyond a predefined area 314 or predefined location 316.

Animal tracking system 300 may be able to communicate with other systems or devices, such as mobile tracking device 318. Mobile tracking device 318 may be any mobile device with the capability to communicate through a network and indicate or display a location of tracking device 100. A smartphone or cellular phone may function as a mobile tracking device if it includes the proper software or application to display the location of tracking device 100, such as on a map. Special purpose mobile tracking devices may also be used.

Animal tracking system 300 may be able to notify, alert, or inform the animal that it has moved near or across a predefined area 314 or predefined location 316. Notifier device 50 may be used to notify, alert, or inform the animal through the means previously described in relation to notifier device 50. Notifier device 50 may utilize energy created from generator 2 to notify the animal. Additionally or alternatively, notifier device 50 may utilize energy stored in rechargeable battery 52 to notify the animal.

The location and tracking capabilities and animal notification capabilities of animal tracking system 300 may be used in combination to maintain an animal in a predefined area 314 or away from a predefined location. Controller 302 may determine if tracking device 100 is within a predefined area 314 or near a predefined location. The determination of controller 302 may be based on the location signals transmitted from tracking device 100. Controller 302 may instruct tracking device 100 and notifier device 50 that the animal should be notified, alerted, or otherwise informed that the animal has moved near or across a predefined area 314 or predefined location 316. Additionally or alternatively, tracking device 100 and/or notifier device 50 may determine that the animal should be notified that it has moved near or across a predefined area 314 or predefined location 316 by other means commonly known in the art, such as invisible fences or underground wires. Any capabilities of animal tracking system 300 may be used in conjunction with known means to track or contain an animal.

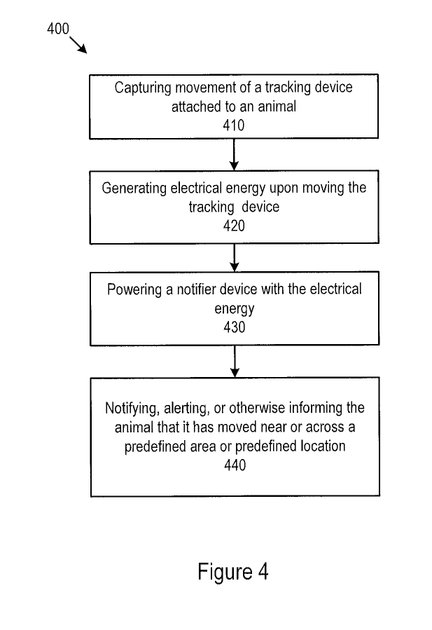

FIG. 4 is a flow diagram of a method for operating an exemplary animal tracking system. Method 400 may be implemented as hardware, software, or both, for example in tracking device 100, controller 302, computer 310, or any combination. Method 400 may start at step 410 by capturing movement of a device attached to an animal, where the device includes a switch, a generator, a transmitter, and a notifier device. A magnetic core, pendulum, or some other weight may capture the movement of the device. For example, when the device moves, the magnetic core captures that movement by moving through a coil of copper wire, or a pendulum begins to swing from a resting position. At step 420, the device may generate electrical energy as a result of the movement captured in step 410. At step 430, the electrical energy generated in step 420 may power a notifier device in the device. At step 440, the notifier device may notify, alert, or otherwise inform the animal that it has moved near or across a predefined area or predefined location. Additional steps may include storing a portion of the electrical energy generated by the device in a rechargeable battery and utilizing the electrical energy stored in the battery to power the notifier device, sending a signal wirelessly from a transmitter to determine the location of the device, determining the location of the device in relation to a predefined area based on the signal sent by the transmitter, or communicating with a mobile tracking device to display the location of the device.

Methods or processes may be implemented, for example, using a processor and/or instructions or programs stored in a memory. Specific components of the disclosed embodiments may include additional or different components. A processor may be implemented as a microprocessor, microcontroller, application specific integrated circuit (ASIC), discrete logic, or a combination of other types of circuits or logic. Similarly, memories may be DRAM, SRAM, Flash, or any other type of memory. Parameters, databases, and other data structures may be separately stored and managed, may be incorporated into a single memory or database, or may be logically and physically organized in many different ways. Programs or instruction sets may be parts of a single program, separate programs, or distributed across several memories and processors.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A tracking system for attachment to an animal, the system comprising:
an actuator coupled to a generator;
a transmitter connected to the generator;
wherein the generator is operable to generate electrical energy, without the use of a battery, upon movement of the actuator;
wherein the transmitter is operable to utilize the electrical energy to send a signal wirelessly indicative of the location of the actuator.

2. The tracking system of claim 1, further comprising a controller in communication with the transmitter, wherein the controller is operable to determine the location of the actuator, and wherein the controller determines the location of the actuator based on the signal sent by the transmitter.

3. The tracking system of claim 1, further comprising a notifier device operable to utilize the electrical energy generated by the actuator to notify the animal when the animal reaches a predefined location.

4. The tracking system of claim 3, further comprising a rechargeable battery connected to the actuator and the notifier device, wherein the rechargeable battery is operable to store a portion of the electrical energy, and wherein the notifier device is operable to utilize the electrical energy stored in the rechargeable battery.

5. The tracking system of claim 3, wherein the predefined location is based on a property boundary.

6. The tracking system of claim 1, wherein the signal provides information regarding the location of the animal attached to the actuator to a recipient of the signal.

7. The tracking system of claim 1, wherein the transmitter is operable to communicate with a mobile tracking device to display the location of the actuator.

8. A tracking system for attachment to an animal, the system comprising:
an actuator integrated with a generator;
wherein the generator is operable to generate electrical energy, without the use of a battery, upon movement of the actuator;
a notifier device connected to the actuator, wherein the notifier device is operable to utilize the electrical energy to notify the animal when the animal reaches a predefined location.

9. The tracking system of claim 8, further comprising a rechargeable battery connected to the actuator and the notifier device, wherein the rechargeable battery is operable to store a portion of the electrical energy, and wherein the notifier device is operable to utilize the electrical energy stored in the rechargeable battery.

10. The tracking system of claim 8, further comprising a transmitter connected to the actuator, wherein the transmitter is operable to utilize the electrical energy to send a signal wirelessly indicative of the location of the actuator.

11. The tracking system of claim 10, further comprising a controller in communication with the transmitter, wherein the controller is operable to determine the location of the actuator, wherein the controller determines the location of the actuator based on the signal sent by the transmitter.

12. The tracking system of claim 8, wherein the predefined location is based on a property boundary.

13. The tracking system of claim 10, wherein the signal provides information regarding the location of the animal attached to the actuator to a recipient of the signal.

14. The tracking system of claim 10, wherein the transmitter is operable to communicate with a mobile tracking device to display the location of the actuator.

15. A method of operating a tracking system attached to an animal, the method comprising:
generating electrical energy upon movement of an actuator that is attached to an animal;
powering a notifier device with the electrical energy;
notifying the animal with the notifier device when the animal reaches a predefined location.

16. The method of operating a tracking system attached to an animal of claim 15, further comprising storing a portion of the electrical energy in a rechargeable battery and utilizing the electrical energy stored in the battery to power the notifier device.

17. The method of operating a tracking system attached to an animal of claim 15, further comprising sending a signal wirelessly from a transmitter to determine the location of the actuator, wherein the transmitter is operable to utilize the electrical energy.

18. The method of operating a tracking system attached to an animal of claim 17, further comprising determining the location of the actuator based on the signal sent by the transmitter.

19. The method of operating a tracking system attached to an animal of claim 17, wherein the signal provides information regarding the location of the animal attached to the actuator to a recipient of the signal.

20. The method of operating a tracking system attached to an animal of claim 17, further comprising communicating with a mobile tracking device to display the location of the actuator.
